(19) United States
(12) Patent Application Publication
(10) Pub. No.: US 2022/0358467 A1
(43) Pub. Date: Nov. 10, 2022

(54) PERMISSIONS FOR RETAILER TYPES WITHIN A MARKETING SYSTEM

(71) Applicant: KwikClick, LLC, Murray, UT (US)

(72) Inventor: Fred Cooper, Farmington, UT (US)

(21) Appl. No.: 17/706,150

(22) Filed: Mar. 28, 2022

Related U.S. Application Data
(60) Provisional application No. 63/166,807, filed on Mar. 26, 2021.
(60) Provisional application No. 63/166,813, filed on Mar. 26, 2021.
(60) Provisional application No. 63/166,817, filed on Mar. 26, 2021.

(51) Int. Cl. G06Q 10/10; G06F 21/62; G06Q 30/02

(52) U.S. Cl. CPC G06Q 10/1093; G06F 21/62; G06Q 30/02

(57) ABSTRACT

Disclosed herein is a method that allows sellers of products to enroll an individual product in a multi-level marketing (MLM) system. Users may be validated to see if they can be allowed to access certain functions that facilitate the sale of products or that are authorized to access certain data controlled based on operation of a computer of an MLM organization. Parties such as a retailer and a manufacture may independently offer commissions for the sale of particular products according to a set of rules set at the MLM organization's computer. Events may be organized to occur at particular times and rules may allow user to earn both standard commissions and bonus commissions based on sales that occur during the time a particular set of rules apply.

### CROSS-REFERENCE TO RELATED APPLICATIONS

The present application claims the priority benefit of U.S. provisional application No. 63/166,807 filed Mar. 26, 2021; 63/166,813 filed Mar. 26, 2021; and 63/166,817 filed Mar. 26, 2021, the disclosures of which are incorporated herein by reference.

### BACKGROUND OF THE INVENTION

### Field of the Disclosure

The present disclosure is generally related to influence-based marketing. More specifically, the present disclosure is related to validating permissions, distributing commissions, and performing other actions associated with a marketing organization.

### Description of the Related Art

A multi-level marketing (MLM) system is a sales strategy used by some direct sales companies to encourage existing distributors to recruit new distributors. Amway, which sells health, beauty, and home care products, is an example of a well-known direct sales company that uses multilevel marketing. Existing distributors are paid a percentage of their recruits' sales. The recruits are referred to as a distributor's “downline.” Distributors also make money through direct sales of products to customers.

Multi-level marketing is, in and of itself, a legitimate business sales strategy. But MLMs are often organized as a pyramid tree. Pyramid “schemes” that use money from new recruits to pay those at the top of the pyramid rather than those who perform valid work or offer legitime services is illegal. As a result, pyramid schemes will involve taking advantage of people by pretending to be engaged in legitimate multilevel or network marketing. Illicit pyramid schemes are often identifiable by their greater focus on recruitment than on product sales. Multi-level marketing companies will typically either sell products primarily to consumers or to its members who must recruit new members to buy their products. In the case of the former, the company is likely a legitimate multilevel marketer. In this case of the latter, there often tend to be issues relative to an illegal pyramid scheme.

While each MLM company dictates its own financial compensation plan and payouts of earnings to their respective participants, all MLM compensation plans will tend to pay out to participants only from two potential revenue streams. The first is paid out from commissions of sales made by the participants directly to their own retail customers.

MLM distributors are expected to sell products directly to end-user retail consumers by means of relationship referrals and word of mouth marketing. But most importantly, they are incentivized to recruit others to join the company's distribution chain as fellow salespeople. As a result, new recruits can become down line distributors for those individuals also working above them.

Current MLM systems do not adequately allow users to interact with computer systems when participating in sales events where standard commissions and bonus commissions may be earned by users. Current MLM systems also do not include ways in which users can be adequately validated to access certain resources of a computer associated with an MLM organization. There is this a need for improved methods and apparatus that allow users to participate in MLM and other related marketing techniques using their personal computing devices and other social networking and engagement tools.

### SUMMARY OF THE PRESENTLY CLAIMED INVENTION

The presently claimed invention is directed to a method and to a non-transitory computer-readable storage medium where a processor executes instructions out of a memory to implement a method for tracking and promoting product sales. In a first embodiment, the presently claimed method includes identifying a first set of rules to apply based on a current time and a schedule that corresponds to a current time window, identifying a first commission schedule to apply to sales of products according to the first set of rules during the current time window, and processing orders according to the first set of rules. The method may also include identifying, according to the schedule that the first set of rules should be changed to a second set of rules associated with a second commission schedule and distributing commissions for receipt by users according to the first commission schedule and the first set of rules based on the orders being processed and fulfilled. Here, the second set of commissions may be applied to additional sales of the products based on the first set of rules being changed to the second set of rules.

In a second embodiment, the presently claimed invention may be implemented as a non-transitory computer-readable storage medium where a processor executing instructions out of a memory to identify a first set of rules to apply based on a current time and a schedule that corresponds to a current time window, identify a first commission schedule to apply to sales of products according to the first set of rules during the current time window, and process orders according to the first set of rules. Here again, the method may also include identifying, according to the schedule that the first set of rules should be changed to a second set of rules associated with a second commission schedule and distributing commissions for receipt by users according to the first commission schedule and the first set of rules based on the orders being processed and fulfilled. The second set of commissions may be applied to additional sales of the products based on the first set of rules being changed to the second set of rules.

### BRIEF DESCRIPTION OF THE DRAWINGS

FIG. 1 illustrates a system for Multi-Level Marketing of products via a set of computing devices.

FIG. 2 illustrates a method that may be performed by a computer such as the administration computer of FIG. 1.

FIG. 3 illustrates a series of steps that may be performed at a user device when a set of instructions associated with validating permissions are executed.

FIG. 4 illustrates steps that may be performed at an administration computer that communicates with a user device.

FIG. 5 illustrates steps that may be performed when product orders are received and when commissions are paid.

FIG. 6 illustrates a series of steps that may be used to identify criteria, rules, and/or commission schedules that should be enforced or applied over time.

FIG. 7 illustrates a computing system that may be used to implement an embodiment of the present invention.

### DETAILED DESCRIPTION

Disclosed herein is a method that allows sellers of products to enroll an individual product in a multi-level marketing (MLM) system. Users may be validated to allow access to certain functions that facilitate the sale of products or data controlled based on operation of a computer of an MLM organization. Parties such as a retailer and a manufacture may independently offer commissions for the sale of products according to a set of rules set maintained by the MLM organization computing network. Events may be organized to occur at particular times. Rules may allow user to earn both standard commissions and bonus commissions based on sales that occur during the time a particular set of rules apply.

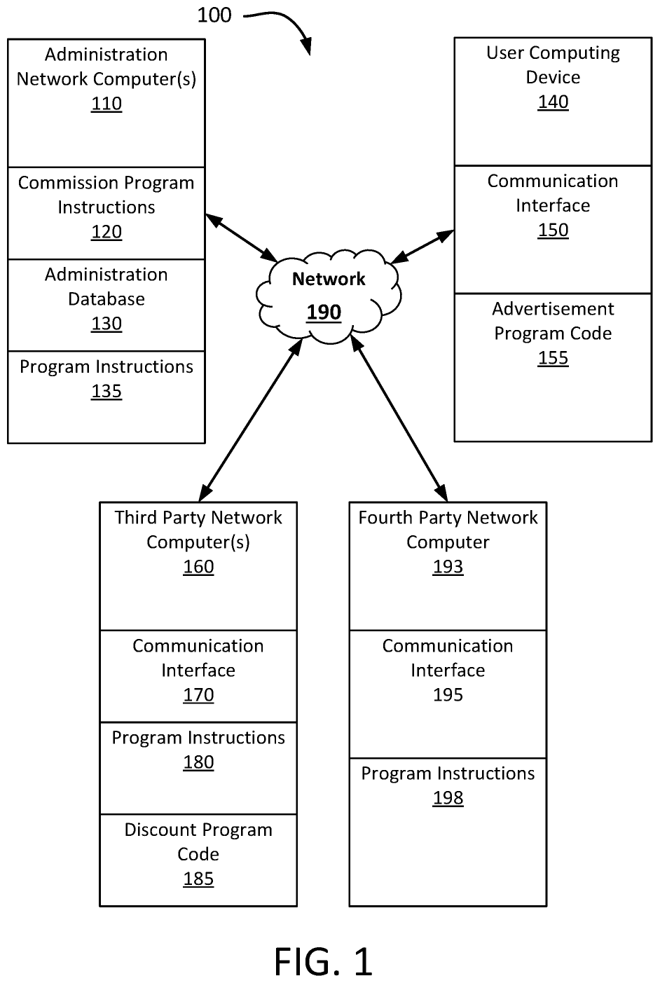

An administration network computer, like that shown in FIG. 1, identifies that a product has been purchased from a user(s) of the system (i.e., a first user). The system may generate an embedded coded hyperlink or other information identifier that connects (links) the referrer to the purchaser(s). This link or related identifier tool may be shared automatically or manually depending on the preference of the referring party. The computer may then automatically pay remuneration, in the form of a commissions, referral, and/or finder fees, to the first user.

Additionally, the purchaser(s) becomes a second user(s) of the system. Should a new individual buy the same product from the second user(s), another embedded coded link or related informational identifier may connect the first user to not only the second user but the new individual(s). Both the first and second user of the system are remunerated for the new individual(s) purchase. This wave of creating and recreating users (1, 2, 3, etc.) based on purchases and linking may be indefinitely iterative. Remuneration on this specific product may be paid to all users linked together in the system each time a purchase is made. The links may be unique and are fixed to each good or service being referred.

FIG. 1 illustrates a system 100 for Multi-Level Marketing of products via a set of computing devices. The system 100 of FIG. 1 includes an administration computer or “administration network” computer 110, a user computing device 140 (user device), and a third-party and fourth-party network computer 160 and 193, respectively. Each of the devices of FIG. 1 (i.e., the administration network computer 110, the third-party 160 and fourth-party 193 network computer, and user device 140) may communicate with each other via a communications network 190 such as the Internet or other cloud computing systems like Amazon Web Services.

A memory at the administration network computer 110 may store commission program instructions 120 and program instructions 135 executed by a computer processor that may validate user access privileges, provide commissions and bonuses, or change commission schedules when during sales promotional events. Computer 110 may also maintain an administration database 130. User device 140 of FIG. 1 may be any user device such as a laptop, smartphone, tablet, computer, or smart device such as a television or speaker that may include a user device communication interface 150 that can access a network. Advertisement program code instructions 155 executed by a computer processor that may allow a user to view or generate promotional materials.

The third-party network computer 160 of FIG. 1 may include program instructions 180 and discount program code instructions 185 executed by a computer processor, a memory, and a communication interface 170, which may be a network interface for accessing a computer or communications network. Program instructions 180 may allow third party vendors or retailers to update or provide product offerings that may be viewed by users accessing the administration network computer 110. Fourth party network computer 193 also maintains basic computer elements (such as a process, memory, and the like) and may access a network through interface 195. Program instructions 198 may allow manufacturers or wholesalers set bonus commissions to help sell products.

A processor at the administration network computer 110 may present, receive, and otherwise manage data regarding sales, execute notification program instructions, track rankings, and effectuate the sending of notifications to users. The administration network computer 110 may receive the sales data from the third-party network computer 160 or other computing devices. Rankings can be identified and notifications can be sent to user devices 140 from administration network computer 110.

In an exemplary use of the system of FIG. 1, a user submits a request to register a product with the administration network computer 110 via a set of discount program code instructions 185 on a third-party network computer 160. A set of program instructions 135 on the administration network computer 110 determine if the requested registration is valid under a set of rules. If the request for registration is valid, the product is registered and stored in the administration database 130.

A user connects a user device 140 to the communication network 190 via the user device communication interface 150. Through the communication network 190, the user device 140 connects with the third-party network computer 160 via the third-party network communication interface 170. A set of third-party network program instructions 180 allow third party vendors or retailers to update or provide product offerings that may be viewed by users accessing the administration network computer 110, Discount program code instructions 185 allow the user to purchase the registered product from the third-party network computer 160 and apply a discount to the product if a user has a code or similar identifier mechanism or tool.

Confirmation of the purchase and the code or identifier are then sent from the third-party network computer 160 to the administration network computer 110. If the user did enter a code or similar identifier, a set of administration network commission program instructions 120 will pay commission to at least another user that is associated with the code. A new code or related identifier is then generated by the administration network 110 per the administration network commission program instructions 120. The new code or identifier is associated with the user of the user device 140. The commission and the newly generated code are stored in the administration network administration database 130.

The administration network computer 110 may also receive sets of filter data from a user device 140 and the administration network computer 110 may then send advertisements, marketing data, or other promotional materials to the user device 140 that match a set of criteria included in the filter data. A user of user device 140 may then be allowed to update marking materials or generate their own advertisements that may be provided to and shared by the administration network computer 110 with other users. Further parties (such as those at fourth-party network computer 193) may also allow their products to be registered for sale with an MLM organization in manner like those discussed above.

Program code instructions of the administration network computer 110 may be organized as one or more software modules that include instructions for performing different functions. For example, a set of commission program instructions 120 may include base program instructions, advertising program instructions, calculation program instructions, influence program instructions, instructions that validate whether certain user can access specific data, instructions used to identify when a user should receive bonuses (i.e., cross-commissions), and vendor program instructions. The administration network computer 110 may also access one or more databases 130, such as a compensation database that stores compensation data and a code database that stores program code or web link data.

The administration network computer 110 may accept sellers (third parties), where a “single product tree” multi-level marketing method is formed. This may involve providing at least one product, providing an MLM system with a seller commission structure, and providing at least one seller of a product with its associated commission structure. The term “single product tree” generally refers to a unique structure for associating distributors of an MLM organization where products are used to identify relationships between distributors and commissions paid to related distributors. This “single product tree” structure allows for a particular user to be considered a sponsor or any other user based on that user sending promotions to other users to purchase a product with which those other users were not previously associated.

The administration network computer 110 may also provide a plurality of buyers/distributors, allow the at least one first seller to enroll a product to the MLM system, and allow at least a first buyer/distributor to purchase the product. Other functions that may be performed by the administration network computer 110 include allowing the at least the first buyer/distributor to advertise the product to other potential buyers/distributors and allowing at least a second buyer/distributor to buy the advertised product. The seller may set a commission structure for a product, may enroll the product into the MLM system, may allow the first, second and so on purchasers/distributors to purchase and advertise the product.

Once products have been enrolled with a commission structure, the administration network computer 110 may allow the purchasers/distributors to receive a commission based upon the seller's product commission structure. A distributor may refer to the non-salaried workforce selling the products or services. The earnings of the participants may be derived from a pyramid-shaped or binary compensation commission system. The term ‘product’ may generally refer to articles or substances manufactured or refined for sale. ‘Product’ may also refer to an individual product, a line of products (such as a unique brand and model of a power tool, like a drill), or a group of products (such as all power tools).

A ‘service’ may generally refer to a system supplying a public need such as transport, communications, or utilities inclusive of electricity or water. A service may also be an act of dealing with a customer like that in a store, restaurant, or hotel by taking their orders, showing them products, or selling them goods. A service may be work that someone does or time that someone spends working for an organization or a business that offers a particular type of help or work.

The system 100 of FIG. 1 may distribute commissions according to an MLM tree or commission tree. The foregoing encompass payment structures in which commissions are given out at different percentages at different levels of the MLM tree. In such a system, distributor (users) that perform the sale or that are at a level that is “closer” to the distributor that performed the sale may receive larger commissions than distributors that are “farther” from the sale.

In another example, a first MLM distributor that performs a sale may receive a higher percentage than a second distributor that sponsored the first distributor. A third distributor that signed up the second distributor may receive a lower commission than the commission received by the second distributor for the sale. Distributors in an MLM tree may be referred as “downline” or “upline” distributors depending on where different users rank on the MLM tree.

For example, a first user that sponsors a second user is “upline” from the second user. The second user, in turn, is “downline” from the first user in the MLM tree. Furthermore, any user/distributor that the second user sponsored would be considered downline from the second user and could be downline from the first user as well for a given MLM product tree.

When a “single product tree” structure is used to identify commissions, users that are downline from the second user may not be downline from the first user based on the second user purchasing and advertising products not associated with the first user. When the first user purchases the product initially advertised by the second user, the second user may be considered upline of the first user after the first user for this product. Because of this, the second user is not relegated to always be downline from the first user just because the first user originally sponsored the second user to become an MLM distributor.

End of life of MLM tree may refer to the end of the MLM tree in which the commission tree may be restructured or eliminated. For example, further participants in the MLM may not receive a commission. The commission tree may also “start up” (be reinitiated from a starting point) again. The commission tree may also be restructured in some other way.

The administration network computer 110 may perform data security functions as well as functions associated with operation of an MLM algorithm. Administration network computer 110 may be able to connect to a software application store like the Apple AppStore or the Google Play Store. Any other locale where a program application can be downloaded may also be included. Data security may refer to the process of protecting data from unauthorized access and data corruption throughout its lifecycle. Data security may include data encryption, tokenization, and key management practices that protect data across all applications and platforms. An MLM algorithm may refer to a calculation performed using a compensation decay rate to calculate the commissions for downline participants.

The commission program instructions 120 of FIG. 1 may cause a computer processor in the administration network computer 110 to poll for user data (e.g., data of a user who may be a product purchaser or product distributor) such as from another processor executing a set of program instructions 180 at a third-party network computer 160. Once the processor of the administration network computer 110 receives the user data, commissions may be calculated using the commission program instructions 120 of FIG. 1. These commissions may be calculated based on data stored in an administration network compensation database 130.

Downline and upline commissions for the other users (product purchasers/distributors) within the MLM tree may be paid. The administration network compensation database may be included within the administration database 130 of FIG. 1 or it may be a separate database accessible by the administration network computer 110. Alternatively, instead of the administration network computer 110 polling a third-party network computer 160, the third-party network computer 160 may send the user data to the administration network computer 110 after a sale has been made or other transaction consummated.

The fourth party may not have a direct way for users to buy products or procure services. Such a fourth party may still be able to offer incentives on their products in addition to the incentives that already exist through the third party network computer 160. This may be done when a processor at a fourth party network computer 193 executes instructions of program code 198 that allow fourth party network computer 193 to integrate commission data or commission bonuses and provide that commission data to an administration network computer 110 or third party network computer 160.

In this example, users could receive commissions from both a first entity (e.g. a retailer) and a second entity (e.g. a manufacturer or a wholesaler). In certain instances, fulfillment of ordered products may be administrated by the first entity and commissions may be paid by both the first entity and the second entity according to commission schedules. These schedules may associate the first entity and the second entity for the purposes of recognizing sales of products or offering of services to members of a MLM organization.

The processor at the administration network computer 110 may also associate a code for each of a different sphere of influence. The administration network computer 110 may then extract a corresponding commission for the code that was retrieved from in the administration network compensation database. The administration network computer 110 may then send the commission to the user (purchaser/distributor).

The administration network computer 110 may track profits and payments as well as track taxes for users enrolled in the MLM system. The tracking of profits and payments may refer to the MLM system tracking the profits of the MLM and tracking the payments or commissions paid out to participants. The tracking of taxes may also refer to tracking the commissions provided to participants for tax purposes.

The administration network computer 110 may then compare the extracted sphere of influence or potential purchaser/distributor to data stored at the administration network compensation database. A sphere of influence may be a set of related users the received marketing materials from each other and that each purchased a particular product. The administration network computer 110 may then use the extracted sphere of influence data to extract a corresponding commission from the administration network compensation database. The administration network computer 110 may then send the commission to an upline user. If the user did not enter a code, the administration network computer 110 may then initiate a set of administration network advertising program instructions.

The administration database 130 may store data received from various third parties (various sellers) that are part of a set of MLM trees. This data may contain a product ID, description of the product, an original cost of the product, a discount for the product, a cost of the product with the discount, a compensation plan decay rate, and a link to the product. An advertising link may refer to a link that directs a consumer to a product, service or good. A product ID may be a set of alphanumeric characters that uniquely identify a particular product.

TABLE 1
Administration Database Data

| 3rd Party | Home Depot | Home Depot | Furniture Store |
|---|---|---|---|
| ID | 654123 | 789654 | 123789 |
| Item | Drill | Table Saw | Couch |
| Original Cost | $59.00 | $119.00 | $999.00 |
| Discount | 15% | 10% | 10% |
| Discount Cost | $50.15 | $107.10 | $899.10 |
| Compensation | 50% | 50% | 30% |
| Decay Rate | | | |

TABLE 1 displays data that may be stored at the administration database 130 of FIG. 1. When the administration network computer 110 receives product data from third party network computer 160 it creates a link or other identifier tool or mechanism for the product, stores the received data in the administration network administration database 130, and sends the created link, tool, or mechanism (collectively ‘link’) back to the third party network computer 160. The administration network administration database 130 may be used to store data collected from various third parties that enrolled in the multi-level marketing system 100 of FIG. 1. The administration network administration database 130 may store the name of the third party, a user ID, the ID for a product, a description of the product, the original cost of the product, the discount provided by the third party, the cost of the product with the discount, the compensation decay rate or how the downline commissions are calculated, and the link to the product. A user ID and product ID may each include a unique set of alphanumeric characters that respectively identify a particular user and a particular product.

The administration database 130 may store data that the administration network computer 110 may access when communicating events with the downlines and uplines, providing dynamic incentives or rewards for a product, distributing marketing materials, providing banking referrals, or distributing materials for suggestive selling. Communicating events with downlines and uplines may refer to sending information relating to advertising events to participants of an MLM system.

Dynamic incentives and rewards for a product may refer to incentives or rewards that are continuously updated for a product. Marketing materials may refer to a means of marketing, advertising or promotional materials developed by or for license (or subject to licensee's approval) that promote the sale of the licensed product. Example of such materials and/or mediums include television, radio, and online advertising, point of sale materials (e.g., posters, counter-cards), packaging advertising, print media and all audio or video media. Banking referrals may refer to a structured flow of collecting and organizing referrals for banks. Businesses who have been unsuccessful in a credit application process with a bank may be asked for their permission to have their financial information passed to designated finance platforms who can contact the business in a regulated timeframe. Suggestive selling may refer to a sales technique where an employee asks a customer if they would like to include an additional purchase or recommends a product which might suit the client.

As mentioned above user device 140 may include a memory, a processor, and a communication interface 150. The processor of user device 140 may execute instructions out of the memory when a user of user device 140 registers as a member of an MLM organization. Other tasks that a user may perform on user device 140 could include, identifying or connecting with other user devices (e.g., follower user devices), preparing advertisement information to share with follower user devices, receiving advertisement information prepared by other users, accessing product promotions at the third party network computer 160, and purchasing products based on offerings received from the third party network computer 160.

Each of the tasks performed by user device 140 may include sending and receiving communications with the administration network computer 110, the third party network computer 160, or other user devices. Promotions prepared at a particular user device may be shared with other user device via administration network computer 110, third party network computer 160, a social media network computer, or directly from one user device to another. User devices may also be required to download and install an application program from an application store like those made available by Apple and Google.

The user device communication interface 150 of FIG. 1 may send and receive data via a communication network 190 which may be a wired and/or a wireless network.

The influence program code instructions 155 may cause the processor to direct the user to a web page associated with a universal resource locator (URL) received in a communication that advertises a product. The URL may be encoded as a part of a QR code or other identifier. When the QR codes is scanned, a computing device that scanned the QR code may be directed to the web page. A QR code scanner may be an input device, such as a camera.

The QR code may also contain non-URL data which may be usable by other program instructions. For example, the QR code may contain a pre-generated referral code or a product ID which, when combined with the user ID, can be used to retrieve a referral code from an administration network code database. This QR code may also include discount information that allows the product to be purchased at a reduced price.

As discussed above the third party network computer 160 of FIG. 1 may include a computer processor a memory, and communication interface 170. This third-party network computer 160 may be controlled by various third parties, such as retail stores (stores that sell product consumables, services, service networks, large box stores) or e-commerce sites that allow e-commerce sales. Such e-commerce sites may include an e-commerce shopping cart, that offer products to users at a discount, such as a product discount, to use the MLM system of FIG. 1.

Product consumables may refer to goods by individuals and businesses that must be replaced regularly because they wear out or are used up. Service networks refer to a collection of people and information brought together on the internet to provide a specific service or achieve a common business objective, such as Angie's List. E-commerce sale may refer to sales of goods and services where the business takes place over the internet, an extra-net, Electronic Data Interchange (EDI), or other online system.

Payment may or may not be made online. Business in this context may be defined as an order placed by the buyer or price and terms of sale negotiated. E-commerce shopping cart may refer to a software used in E-commerce to assist visitors to make purchases online. Upon checkout, the software calculates the total of the order, including shipping and handling, taxes, and other parameters the owner of the site has previously set.

Retailer may refer to a person or business that sells goods to the public in relatively small quantities for use or consumption rather than for resale. Product discounts may refer to a reduce price or something being sold at a price lower than that product is normally sold for. It is a reduction to a basic price for a good or service. Large box stores may refer to a physically large retail establishment, usually part of a chain of stores, offers a variety of products to its customers. The term sometimes refers, by extension, to the company that operates the store, and which may be referenced as a supercenter, superstore, or megastore. These stores achieve economies of scale by focusing on large sales volumes. Because volume is high, the profit margin for each product can be lowered, which results in very competitively priced goods.

The third-party network program instructions 180 and discount program code instructions of FIG. 1 may be executed by a computer processor after being initiated by a set of third party network base program instructions. These instructions may cause the processor at the third party network computer 160 to prompt user for a discount code and to compare a received code to data stored at a third party network third party database. When a code received from a user matches data stored at the databases, a discount for the selected product may be applied and an order for a product may be processed.

The discount program code instructions 185 may allow a user to register products and a set of associated parameters with the administration network computer 110. Registration may be governed by certain parameters falling within the allowed values set by various rules of the system. These product parameters may include, for example, the product ID, the name, the cost, the discount, or the compensation decay rate.

The communications network 190 of FIG. 1 may be any network allowing for the exchange of data information, including the Internet or other cloud services. This communication network or any of the communication network interfaces 150 or 170 discussed herein may be a wired and/or a wireless network. Such a communication network, if wireless, which may be implemented using communication techniques known in the art. The communication network may allow ubiquitous access to shared pools of configurable system resources and higher-level services that can be rapidly provisioned with minimal management effort, often over Internet and relies on sharing of resources to achieve coherence and economies of scale, like a public utility, while third-party clouds enable organizations to focus on their core businesses instead of expending resources on computer infrastructure and maintenance.

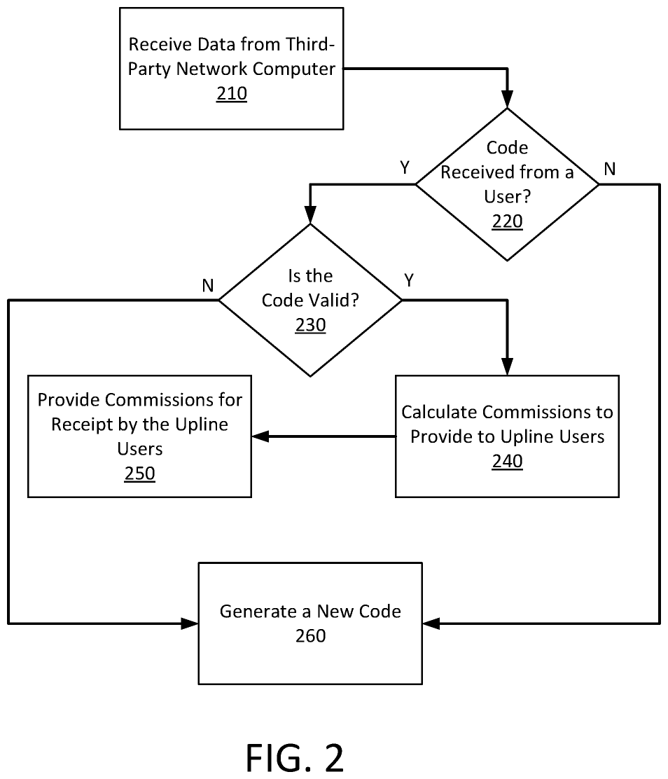

FIG. 2 illustrates a method that may be performed by a computer such as the administration computer of FIG. 1. FIG. 2 begins with step 210 where the administration network computer 110 receives data from the third party network computer 160 of FIG. 1. The received data may contain information on a purchased product and the discount code that can be applied to the purchase.. The administration network computer 110 may determine if the data received from the third party network computer 160 contains a code at step 220. When the data does contain a code, the administration network computer 110 checks that both the product and the code match data stored at the administration network administration database 130 and/or other databases. The product and code may then be checked to see if they are valid at step 230 of FIG. 2. When the code and product are valid, the computer at administration network computer 110 may calculate commissions due to each upline user at step 240.

The commissions may be calculated by using the discount on the product and providing a discount at a particular percentage to the user who supplied the code and then the remaining amount of the discount for the upline users at the remaining portion of the decay rate. For example, if the first user purchased a product that was originally $59.00 discounted by 15%, then a second user makes a purchase with the first user code at a 50% discount is at issue, the second user would receive $3.32 or 50% of the discount. Then any follower of the second user who uses the second user code would cause the second user to receive 50% of the discount and the first user to receive 50% of the remaining discount or 50% of $3.32. This process may continue until there is only one cent left to pay out as a commission for the upline users. The threshold at which commission stops may be greater or less than one cent and may be set dynamically.

The administration network computer 110 may distribute the commission to the upline users at step 250 of FIG. 2. Commission may be paid directly to a user via the user device 140 of FIG. 1. The data may be stored in a database, for example, an administration network compensation database discussed above. Whether or not a valid code was entered, the administration network computer 110 may generate a new code for the user such that the user can give the code to followers and receive commission on their purchases at step 260 of FIG. 2. This generated code may be stored in the administration database 130 of FIG. 1 or another database, for example an administration network code database. A set of instructions in the administration network base program may instruct the administration network computer 110 to connect to the third-party network computer 160, initiate a set of vendor program instructions, and initiate a set of calculation program instructions.

A set of administration network calculation program instructions may administration network computer 110 to apply a discount and identify commissions that should be paid to particular users. Once identified, this commission data may be stored data in a database at the administration network computer 110 of FIG. 1. A commission may refer to a payment to someone who sells goods that are directly related to the amount sold, or a system that uses such payments. A compensation plan or a commission plan may refer to the decay rate of the commissions provided to the MLM system from the discount offered by the third party, the third party also selects the decay rate to calculate the commissions offered to the first purchaser as well as the percentage offered to the downline participants.

An administration network compensation database, which may be created through operation of the administration network calculation program instructions, may store various commissions for the different product purchasers/distributors. TABLE 2 illustrates data that may be stored at a compensation database consistent with the present disclosure.

The administration network compensation database may store information that cross-references a third party, a product ID, product description, the compensation plan decay rate, the various sphere of influence levels, a commission for each sphere of influence level, and a code to be used by the user's followers to enroll in the MLM system of FIG. 1. The administration network compensation database may store a lottery structure for how the commissions are paid to users or freelancers. This lottery structure may refer to a process or thing whose success or outcome is governed by chance. A means of raising money by selling number tickets and giving prizes to the holders of number drawn at random. Freelancers may refer to a person who works as a writer, designer, performer, or the like, selling work or services by the hour, day, job, etc., rather than working on a regular salary basis for one employer.

TABLE 2
Compensation Database Data

| Third Party | Home Depot | Home Depot | Home Depot |
|---|---|---|---|
| ID | 654123 | 654123 | 654123 |
| Item | Drill | Drill | Drill |
| Compensation | 50% | 50% | 50% |
| Decay | | | |
| Rate | | | |
| Sphere of | First | 2 | 3 |
| Influence | Participant | | |
| Level | | | |
| Commission | $3.31 | $1.66 | $0.83 |
| Code | N/A | 654123-SOI2 | 654123-SOI3 |

TABLE 3 illustrates data that may be store at an administration network code database. This data may identify the codes given to the product purchasers/distributors (users) for the product purchasers/distributors (user) to pass to their potential purchasers/distributors to advertise or promote a product that a user has purchased. The administration network code may also cross-reference a user ID with a product ID, and product name, a sphere of influence (potential purchaser/distributor), and a code that may be shared with followers.

TABLE 3
Code Database Data

| | | | Product and | Code for |
|---|---|---|---|---|
| User ID | ID | Item | User Relationships | Followers |
| JS1234 | 654123 | Drill | First Participant | 654123-SOI2 |
| HY8569 | 654123 | Drill | Second Participant | 654123-SOI3 |
| TB4567 | 789654 | Table Saw | First Participant | 897456-SOI2 |
| EL51346 | 789654 | Table Saw | Second Participant | 897456-SOI3 |

Stored data may store a user ID, for example, JS1234, which is used to identify the user or a user device associated with a user. A database may store a membership status, for example, “premium member”, and a list of software modules and databases associated with that membership status, “Advanced Analytics Database, Premium Member Module.” A premium member may be offered greater discounts or may be able to access data that allows them to access offerings that are not provided to non-premium members. Membership status may grant permissions to default modules and databases, which may then be customized by adding or subtracting permissions from the list.

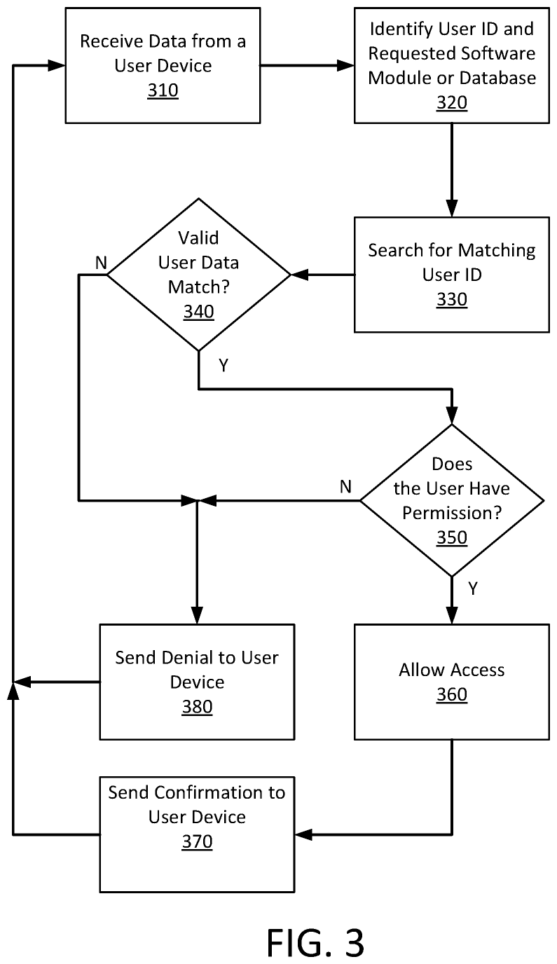

FIG. 3 illustrates a series of steps that may be performed at a user device when a set of instructions associated with validating permissions are executed. The method of FIG. 3 may include receiving data from a user device in step 310. This data may have been received based on an administration computer polling for received user device data.

The received data may then be parsed in step 320 to identify a user identifier and information that identifies whether the received user ID is associated with functions of a premium software module or with a particular database. The received user data may include an identifier that identifies the name of the premium or other software module or an identifier that identifies a particular database. This may include the administration network computer extracting the user ID and identifier for the software module or database.

A search may then be performed in step 330 for a user ID that matches an existing user. Determination step 340 may the identify whether there is a matching user ID associated with the MLM organization. This allows the administration network computer to validate a particular user or user credentials. When the data received in step 310 is not associated with a valid user, a denial notification may be sent to the user device from which the data was received in step 380. Program flow may then move to step 310 where additional data may be received from user devices.

When determination step 340 identifies that the user is a valid user, program flow may move to determination step 350 that identifies whether there are any permissions associated with the user ID. Determination step 350 may also identify if the permission is consistent with the software module and/or the particular database identified in step 320. When determination step 350 identifies the user does not have permission to access the software module and/or the particular database, program flow may move to step 380 where the denial notification may be sent to the user device in step 380 and then program flow may move back to step 310 where additional data may be received from user devices.

When determination 350 identifies the user does not have permission to access the software module and/or the particular database, program flow may move to step 360 of FIG. 3. Step 360 may allow a user device to access functions of the software module identified in step 320. These functions may allow the user device to access data at a e database. Access to a database may result in data at the database to being sent to the user device in step 360. After step 360, the administration network computer may send a message to the user device indicating that the user device is allowed to access the requested data and the data may be provide to the user device in step 370 of FIG. 3.

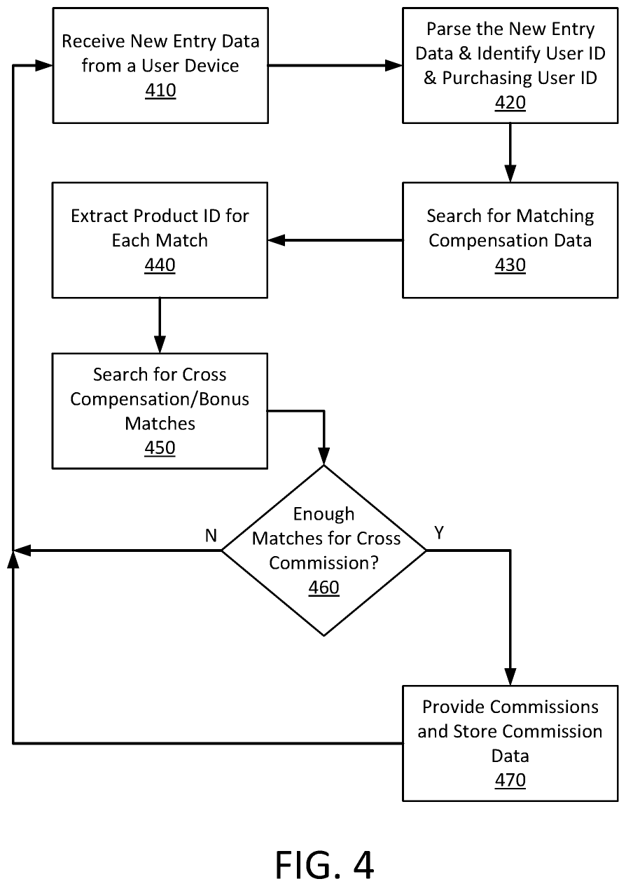

FIG. 4 illustrates steps that may be performed at an administration computer that communicates with a user device. Step of FIG. 4 may be performed to identify whether bonus commissions compensations should be provided to particular users. FIG. 4 begins with step 410 where data associated with a new entry data (e.g. a set of criteria relating to product sales or products offered for) is received from a user device. This new entry data may be received based on an administration network computer polling for new entry data. This new entry data may correspond to or be included in a new data record that is stored at a database that stores compensation information. This compensation database may store data associated with commissions that are provided for receipt by MLM users.

The data received in step 410 may be parsed to identify a user identifier (ID) and a purchasing user ID in step 420 of FIG. 4. Next the compensation database may be searched for any entries that match both the user ID and purchasing user ID. These matches may account for all commissions received by a user associated with the user ID due to any product purchase by a user associated with the purchasing ID. A first user associated with the user ID and a second user associated with the purchasing ID may not be directly downline and upline of one another.

Next in step 440 product IDs associated with each match identified in step 430 may be extracted. Program flow may then move to step 450 where one or more databases are searched for cross-compensation data that matches the product IDs. Multiple matches for the same product ID may be identified is step 450. Then determination step 460 may identify whether there are enough matches within a single marketing campaign to award the user a bonus commission.

Bonus commissions or additional compensations may be distributed only when the user has met a set of criteria. For example, a criterion may require that a user be associated with purchases of a particular set of products that the marketing campaign is directed to before a bonus commission is provided to the user. In other instances, the criterion may identify that the user can only be associated with sales of some of the products during a time span of the marketing campaign to qualify to receive a bonus commission. Bonus commissions may scale (i.e. increase) with a number of matching products that the user is associated with. For example, a campaign with three products may award a bonus of $5 to a user when that user is associated sale of two of the three products of the campaign. In instances when the user is associated with sales of all three products of the campaign, the user may receive a bonus of $10. When determination step 460 identifies a user has not met a set of sales criteria (is not associated with enough matches to receive a bonus cross commission), program flow may move back to step 410 where additional data may be received from a user device.

In certain instances, there may be additional requirements for a bonus commission to be awarded. Products in a campaign may need to be purchased within a set time window or the same transaction. It may be required that one product in the campaign be related to the purchase of another product in order to qualify. For example, if product A is a gift card or credit card, and product B is a drill, then the bonus commission may only be awarded if a purchaser uses the credit card to buy the drill. In another example, product A may be a membership to an organization that sells product B to both members and non-members. A user would only receive the bonus commission if the purchaser was still a member when they purchased product B. When there are enough matches for cross compensation, a bonus may be sent for receipt by users and information identifying these bonuses may be stored in the commission database. This record may be used to ensure that bonus commissions are not paid multiple times for the same purchaser unless of course that is part of the bonus criteria.

When determination step 460 identifies that a user has met the criteria (is associated with enough matches to receive a bonus commission), program flow may move to step 470 where the commissions are provided and data is store identifying the commissions that have been provided. After step 470, program flow may move back to step 410 where additional data may be received from a user device. Cross-compensations of the present disclosure allow users to earn both normal commissions and then also earn bonus commissions based on meeting a rule or criteria associated with selling a number of products. An administration network computer may initially provide commissions for a third party or a forth party and then the administration computer may receive payment for those commissions from a third party and/or a forth party computer.

Table 4 illustrates data that cross-references criteria of different marketing campaigns and bonuses that may be distributed to users that associated with sales that meet the criteria.

TABLE 4
Campaign-Bonus Criteria

| | Product | Product | Product | Bonus |
|---|---|---|---|---|
| Campaign | ID | ID | ID | |
| 1 | 654123 | 654124 | 654128 | $5.00 |
| 2 | 574893 | 475836 | N/A | $40.00 |
| 3 | 668594 | 400467 | 123478 | $7.55 |

The data of table 4 may be stored at a database that stores information regarding bonuses that can be awarded to users that cross-promote the sale of different products. The data of table 4 includes a campaign identifiers (1, 2, 3) cross-referenced with a number of different product identifiers (IDs), and bonus amounts. The database may include a bonus commission that is associated with a rule or criteria, for example, $5, which is earned by a user whenever the user sells or a buyer purchases at least two products in the campaign. As mentioned above, a rule or criteria may require all products in the campaign to be purchased for the bonus to be earned. Alternatively, the bonus compensation may only require some of the products in the campaign to be purchased to be awarded. In certain instances, the bonus compensation may scale with the number of products purchased. For example, a campaign with 3 products may award a bonus of $5 if any two are sold by the same seller to a same buyer and an award of $10 if all 3 are sold to the same buyer.

Other data that may be stored at a database may track compensation amounts that have been provided to specific sellers. For example, when user assigned user identifier JS1234 promotes product with identifier 654123 to a buyer that is assigned purchaser ID RJ4128, and a user associated with ID RJ4128 buys product A654123, the user with user ID JS1234 may receive a bonus and data reflecting this purchase may be stored at a database. This data may also include how much compensation or bonus compensation was received by different users for the sale of different products.

A set of instructions referred to as user device purchase program instructions may allow a user device to connect to the third party network computer 160, allow a purchaser/distributor to select a product and an associated link. This process may include, determining whether the purchaser/distributor entered a code, and sending the link and code, if available, to the third party network computer 160.

A set of instructions referred to as purchase program instructions may cause the user device 140 to continuously poll for a request from the administration network computer 110 for user device user database data. The user device 140 may then receive a request from the administration network computer 110 for the user device user database data. Then the user device 140 may send the user device user database data to the administration network computer 110. The user device 140 may then connect to the third party network computer 160. Then the user may select a product from the third party network computer 160. The user may select a link from the third party network computer 160. Then the user device 140 if the user entered a code. If it is determined the user entered a code, the user device 140 may send the code to the third party network computer 160. The user data may be data to purchase the product such as name, address, billing information, etc. The user data sent to the third party network computer 160 may include information from a credit card system. A credit card system may refer to a system that allows cardholders to borrow funds with which to pay for goods and services with the condition that the cardholders pay back the borrowed funds, plus interest, as well as any additional agreed-upon charges.

A user device user database may contain the user's (product purchasers/distributors) followers (sphere of influence) as well as the followers contact information for them to receive commissions on their purchases. A distributor contact list or followers may refer to the recruits or followers on social media that a distributor has secured to participate in their downline. The user device user database may include ratings and recommendations from the users. Rating and recommendation modules may refer to modules in which a company, entity, or person provides ratings and/or recommendations for products, goods, or services.

Table 5 displays data that may be stored at a user device database. The data of table 5 cross-references user information with user follower information. The user device user database stores the user's ID, the followers user ID, codes provided to the followers, the follower's e-mail address, the follower's phone number, and the follower's address. The user device database may store the follower's social media information such as user social media account information (Twitter, Instagram, Facebook, etc.). The user database may contain social media plug-ins for enhanced marketing or social media aggregators. Social media plug ins for enhanced marketing may refer to sharing content with other people through social media platforms, for example a share or like button. The user device user database may contain payment information such as bank accounts, credit card information, PayPal, Venmo, etc. A user ID or ID Enrollment may refer to a participant enrolling in an MLM product tree through an ID, which may be unique to each participant in the MLM system. Social media aggregators may refer to a tool that allows a person to collate posts and updates from many different social media feeds. It creates an organized view of social posts on a specific topic and are often used to display user-generated content on live social walls.

TABLE 5
User Database Data

| | | | |
|---|---|---|---|
| User ID | JS1234 | JS1234 | JS1234 |
| Follower ID | HY8569 | IT8527 | RW4569 |
| Code for | 654123-SOI2 | 654123-SOI2 | 654123-SOI2 |
| Followers | | | |
| Follower E-mail | HY8569@gmail.com | IT8527@yahoo.com | RW4569@gmail.com |
| Follower Phone | 781-654-8972 | 231-456-7891 | 654-987-3217 |
| Follower | 123 Main Street, Boston, | 58 Elm Street, | 96 2nd Ave, Salt |
| Address | MA | Burlington, VT | Lake City, UT |

Operation of a set of user device downline program instructions may cause the user device 140 to continuously poll to receive the code and link from the administration network computer 110 to allow the purchaser/distributor to pass the code and link to the user's followers stored in the user device user database. Functioning of the downline program instructions may be as follows. The process begins with the user device 140 continuously polling for the code and the link from the administration network computer 110. The user device 140 receives the code and the link from the administration network computer 110. The user device 140 provides a selection of the first follower in the user device user database. The user device 140 extracts the followers contact information stored in the user device user database. Then the user device 140 sends the code and link to the follower's contact information. The code and link may be shared on social media sites, such as Twitter, Instagram, Facebook, etc. This may allow the user's followers to receive the code and link based on communications that use one or more of these social media accounts. The user device 140 may then determine if there are more followers remaining in the user device user database. If it is determined that there are more followers stored in the user device user database, the user device 140 selects the next user stored in the user device user database. When the user device 140 determines that there are no more followers remaining in the user device user database, then the process may end.

Methods of the present disclosure may include a user device 140 polling for a new universal resource locator (URL) that may have been detected after a quick release (QR) code scanner scans a QR code. The data captured by the QR code scanner may contain data in addition to or in lieu of a URL. The administration network computer 110 may then send the URL to a web browser on the user device 140 so that the user device is directed to the website the URL points to. Third parties may design this webpage so that users can easily refer others to make the same purchase they did or purchase from the same third party or third party computer. Website URLs may be product, user, location, or discount code specific, or may be general but could require the user to provide information before granting the user a referral code or link.

A third party network computer 160 may execute administration program instructions to cause the third party network computer 160 to connect to the administration network computer 110, send the data for the products to be purchased, receive a link from the administration network computer 110, store the link in a third party network database, and return to executing a set of base program instructions. The process may begin with the third party network computer 160 administration program instructions being initiated by the third party network base program instructions. The third party network 160 may connect to the administration network computer 110 and then the third party network computer 160 may send third party network database data to the administration network computer 110. Then the third party network computer 160 may store the link in the third party network third party database.

Operation of a third party network discount program code instructions may include extracting a link sent by the user device 140 and comparing it to data stored at the third party network third party database. This may result in the identification of a corresponding discount for a selected product. This process may include identifying whether a user entered a code or not, after which a discount is applied, and the order is processed.

The process of applying a discount may begin by extracting the link received from the user. Then the third party network computer 160 may compare data included in the extracted link to data stored at the third party network database. The third party network computer 160 may then extract a corresponding discount from the third party network third party database. Then the third party network computer 160 may apply the extracted discount to the user's order. The third party network computer 160 may then determine if the user entered a code. When it is determined that the user did not enter a code, the third party network computer 160 may send the user data to the administration network computer 110 without a code. When it is determined that the user entered a code, the third party network computer 160 may send the code and the user data to the administration network computer 110. Next, the third party network computer 160 may process the user's order.

A third party network third party database may store information about the products that may be purchased. This the third party network database may include local media for the product or service, where this local media may refer to the various types of media, such as photos, videos, text, sounds, haptics, online product descriptions, etc. for enhanced marketing.

Table 6 illustrates data that may be stored at a third party database. This data may include information about the products enrolled in the MLM system as well as a link created by execution of the administration network vendor program instructions. The third party network database may cross-reference a product ID, and product description, an original cost of the product, a discount provided by the third party for the product, a cost of the product with the discount, a compensation plan decay rate which the third party enters, and a link received from the administration network computer. The third party network third party database may include the rates of exchange for product returns, marketing materials, airline sky miles, etc. Product returns may refer to a process in which a customer or consumer takes previously purchased product, merchandise, or goods back to the retailer, and in turn receive a refund in the original form of payment, exchange for another product (identical or different), or a store credit.

The information about the product or service which may be advertisements to the network, or as seen on TV sales. Advertisements to the network may refer to the advertisement provided to the MLM system from the third party offering a product, good or service. These as seen on TV sales may refer to a generic nameplate for products advertised on television in the United States for direct response mail-order through a toll-free telephone number. Marketing materials may refer to a means of marketing, advertising or promotional materials developed by or for license (or subject to licensee's approval) that promote the sale of the licensed product, including but not limited to, television, radio and online advertising, point of sale materials (e.g., posters, counter-cards), packaging advertising, print media and all audio or video media. Airline sky miles may refer to a loyalty program offered by airlines and/or credit cards. Typically, consumers accumulate a set amount of miles based on how much is spent on a ticket or a credit card and are also known as frequent flyer miles or travel points.

TABLE 6
Third Party Database Data

| | |
|---|---|
| ID | 654123 |
| Item | Drill |
| Original Cost | $59.00 |
| Discount | 15% |
| Discount Cost | $50.15 |
| Compensation Decay | 50% |
| Rate | |
| Link | HDDrill654123 |

Table 7 includes data that may be associated with sales of product by a vendor or fourth party, Black & Decker. The data of table 7 cross-references products make by Black & Decker identified using product ID 654123, with a sell or influencer identifier (ID) MK4837, various commissions, and commission codes (e.g. 485739-IF-01) that may be used to distribute or track distributed commissions. Here the influencer ID may identify a particular seller/user that has marketed a product identified by product ID 654123.

TABLE 7
Vendor Commission Cross Reference Data

| | | Influencer | | |
|---|---|---|---|---|
| | Product | or Seller | | Commission |
| Vendor | ID | ID | Commission | Code |
| Black & | 654123 | MK4837 | $5.00 | 485739-IF01 |
| Decker | | | | |
| Black & | 654123 | MK4837 | $3.00 | 485739-IF02 |
| Decker | | | | |
| Black & | 654123 | MK4837 | $1.65 | 485739-IF03 |
| Decker | | | | |
| Black & | 654123 | MK4837 | $0.82 | 485739-IF04 |
| Decker | | | | |

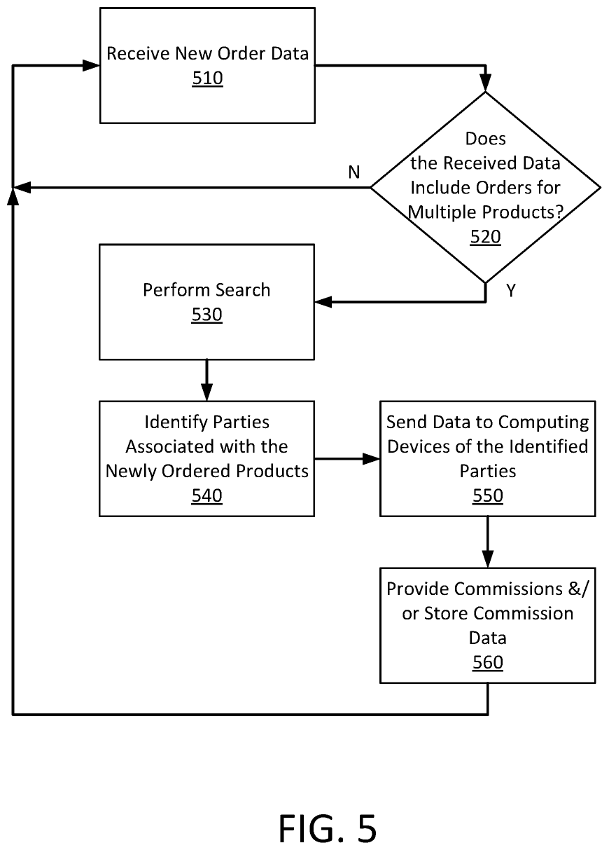

FIG. 5 illustrates steps that may be performed when product orders are received and when commissions are paid. FIG. 5 begins with step 510 where data relating to a new order is received. This data may be received based on an administration network computer polling a third party computer (or a fourth party computer) for order data or the third party computer sending data to the administration network computer. The administration network computer may continue to poll for additional orders associated with a same seller or that are associated with a same buyer within a time window. For example, if a user purchases a drill from one vendor and a battery from another within an hour, those transactions may be close enough in time to be considered purchased together. Determination step 520 may identify whether the new order data includes orders for multiple products, when now, program flow may move back to step 510 of FIG. 5.

When determination step 520 identifies that the new order data includes orders for more than one product, program flow may move to step 530 where a search is performed. Data included in the new order or associated with the search may include or identify a product name, product ID, or some other identifier. This may result in a party or parties associated with the newly order products being identified at step 540 of FIG. 5. An administration network computer may then send data associated with items purchased together to the respective parties identified in step 540. This data may be sent directly to a database or via another means of communication such as email, text, etc. in step 550. Step 550 may include sending communications to a seller, a buyer, a third party computer, or fourth party computer that identifies sales information or commission that have been, that will be paid, or that should be paid by a third or fourth party. This may inform or more entities of details associated with product orders.

After step 550, step 550 may provide commissions to users or may store data that identifies commissions paid to particular users at a database. The steps of FIG. 5 may be used to identify when bonus commissions should be paid to particular users. When sales of a product associated with a certain user reach a threshold, bonus commissions may be paid. As mentioned above this may be part of a marketing campaign that lasts for a limited amount of time. The commissions paid to particular users may be associated with commission schedules of more than one entity, for example a retailer and a manufacturer as discussed above.

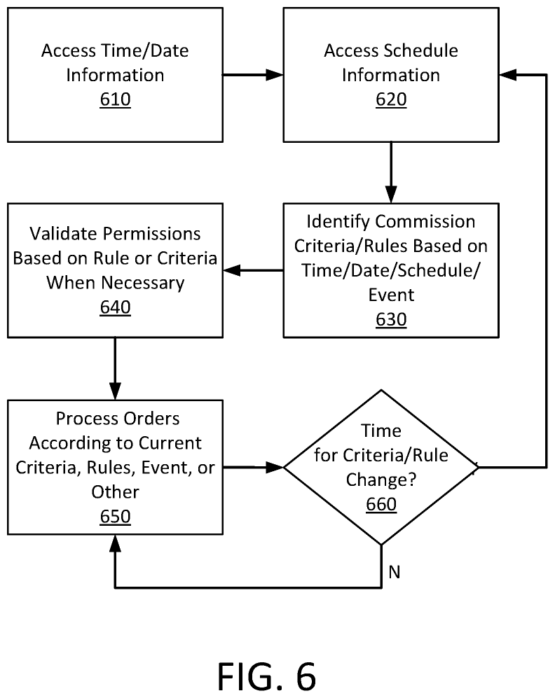

FIG. 6 illustrates a series of steps that may be used to identify criteria, rules, and/or commission schedules that should be enforced or applied over time. The steps of FIG. 6 may be used to identify when a promotional event begins or ends, may be used to identify if or when cross compensations should be applied, when normal commission schedules should be applied, or both. FIG. 6 begins with step 610 where time and date information is accessed. Next schedule information may be accessed in step 620. Depending on what a current time and/or date is, a particular commission schedule may be applied based on the time, the date, and/or an event schedule in step 630.

In certain instances, different commissions schedules may be applied to different groups of users based on rules of an MLM organization. A first user group may be allowed to participate in a first event at a time when a second user group is allowed to participate in a second event. Particular users may be directed to certain types of promotional events or normal commission schedules based on the time, date, and schedule details. This may include validating permissions of certain users based on a criteria or rule in step 640 of FIG. 6. Permissions may be validated according to the steps of FIG. 3. Those users with a user ID that corresponds to particular sets of software program code or database information may be allowed to participate either normal purchasing activity or purchasing activity associated with an event. Commission schedules may be changed dynamically over time and may correspond to constraints identified by a third party that operates third party computer 160, a fourth party that operates fourth party computer 193, or by an administration entity that operates administration computer 110 of FIG. 1.

Criteria associated with product sales according to a schedule and possibly a user group may determine whether rules consistent with the steps of FIG. 5 should be performed, whether cross compensation bonuses should be applied, or whether other compensation schedules should be applied to sales associated with a particular timeframe, to users of a particular user group, or users that have made purchases based on recommendations from related users. Next in step 650 orders may be processed according to a current criteria, a current event, or other rules. After step 650, program flow may move to step 660 that identifies whether it is time for the criteria or rules to change, when no program flow may move back to step 650 where orders according to the current criteria, the current event, or current circumstance/rule continue to be applied. When determination step 660 identifies that is time to change the criteria or the rules, program flow may move back to step 620 where schedule information is accessed again. Rules or criteria may also be used to identify when certain types of discounts should be applied.

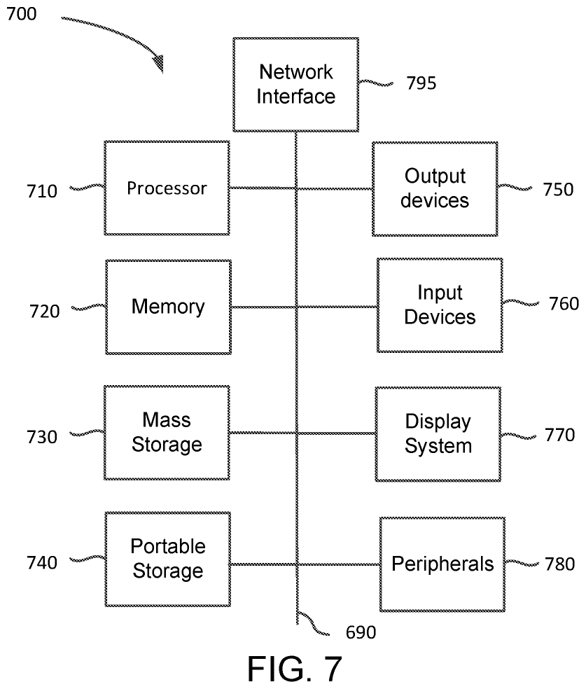

FIG. 7 illustrates a computing system that may be used to implement an embodiment of the present invention. The computing system 700 of FIG. 7 includes one or more processors 710 and main memory 720. Main memory 720 stores, in part, instructions and data for execution by processor 710. Main memory 720 can store the executable code when in operation. The system 700 of FIG. 7 further includes a mass storage device 730, portable storage medium drive(s) 740, output devices 750, user input devices 760, a graphics display 770, peripheral devices 780, and network interface 795.

The components shown in FIG. 7 are depicted as being connected via a single bus 790. However, the components may be connected through one or more data transport means. For example, processor unit 710 and main memory 720 may be connected via a local microprocessor bus, and the mass storage device 730, peripheral device(s) 780, portable storage device 740, and display system 770 may be connected via one or more input/output (I/O) buses.

Mass storage device 730, which may be implemented with a magnetic disk drive or an optical disk drive, is a non-volatile storage device for storing data and instructions for use by processor unit 710. Mass storage device 730 can store the system software for implementing embodiments of the present invention for purposes of loading that software into main memory 720.

Portable storage device 740 operates in conjunction with a portable non-volatile storage medium, such as a FLASH memory, compact disk or Digital video disc, to input and output data and code to and from the computer system 700 of FIG. 7. The system software for implementing embodiments of the present invention may be stored on such a portable medium and input to the computer system 700 via the portable storage device 740.

Input devices 760 provide a portion of a user interface. Input devices 760 may include an alpha-numeric keypad, such as a keyboard, for inputting alpha-numeric and other information, or a pointing device, such as a mouse, a trackball, stylus, or cursor direction keys. Additionally, the system 700 as shown in FIG. 7 includes output devices 750. Examples of suitable output devices include speakers, printers, network interfaces, and monitors.

Display system 770 may include a liquid crystal display (LCD), a plasma display, an organic light-emitting diode (OLED) display, an electronic ink display, a projector-based display, a holographic display, or another suitable display device. Display system 770 receives textual and graphical information, and processes the information for output to the display device. The display system 770 may include multiple-touch touchscreen input capabilities, such as capacitive touch detection, resistive touch detection, surface acoustic wave touch detection, or infrared touch detection. Such touchscreen input capabilities may or may not allow for variable pressure or force detection.

Peripherals 780 may include any type of computer support device to add additional functionality to the computer system. For example, peripheral device(s) 780 may include a modem or a router.

Network interface 795 may include any form of computer interface of a computer, whether that be a wired network or a wireless interface. As such, network interface 795 may be an Ethernet network interface, a BlueTooth™ wireless interface, an 802.11 interface, or a cellular phone interface.

The components contained in the computer system 700 of FIG. 7 are those typically found in computer systems that may be suitable for use with embodiments of the present invention and are intended to represent a broad category of such computer components that are well known in the art. Thus, the computer system 700 of FIG. 7 can be a personal computer, a hand held computing device, a telephone (“smart” or otherwise), a mobile computing device, a workstation, a server (on a server rack or otherwise), a minicomputer, a mainframe computer, a tablet computing device, a wearable device (such as a watch, a ring, a pair of glasses, or another type of jewelry/clothing/accessory), a video game console (portable or otherwise), an e-book reader, a media player device (portable or otherwise), a vehicle-based computer, some combination thereof, or any other computing device. The computer can also include different bus configurations, networked platforms, multi-processor platforms, etc. The computer system 700 may in some cases be a virtual computer system executed by another computer system. Various operating systems can be used including Unix, Linux, Windows, Macintosh OS, Palm OS, Android, iOS, and other suitable operating systems.

The present invention may be implemented in an application that may be operable using a variety of devices. Non-transitory computer-readable storage media refer to any medium or media that participate in providing instructions to a central processing unit (CPU) for execution. Such media can take many forms, including, but not limited to, non-volatile and volatile media such as optical or magnetic disks and dynamic memory, respectively. Common forms of non-transitory computer-readable media include, for example, a FLASH memory/disk, a hard disk, magnetic tape, any other magnetic medium, a CD-ROM disk, digital video disk (DVD), any other optical medium, RAM, PROM, EPROM, a FLASH EPROM, and any other memory chip or cartridge.

While various flow diagrams provided and described above may show a particular order of operations performed by certain embodiments of the invention, it should be understood that such order is exemplary (e.g., alternative embodiments can perform the operations in a different order, combine certain operations, overlap certain operations, etc.).

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen in order to best explain the principles of the technology and its practical application to thereby enable others skilled in the art to best utilize the technology in various embodiments and with various modifications as are suited to the particular use contemplated. It is intended that the scope of the technology be defined by the claim.

What is claimed is:

1. A method for merchandising products, the method comprising:
identifying a first set of rules to apply based on a current time and a schedule that corresponds to a current time window;
identifying a first commission schedule to apply to sales of products according to the first set of rules during the current time window;
processing orders according to the first set of rules;
identifying, according to the schedule, that the first set of rules should be changed to a second set of rules associated with a second commission schedule; and
distributing commissions for receipt by users according to the first commission schedule according to the first set of rules based on the orders being processed and fulfilled according to the first set of rules, wherein the second set of commissions are applied to additional sales of the products based on the first set of rules being changed to the second set of rules.

2. The method of claim 1, further comprising:
receiving data from a user device that includes a user identifier (ID) and access request information;
accessing a database that stores authorization data; and
identifying that the user ID and the access request matches the authorization data; and wherein the user device is authorized to receive data associated with the sales of the products based identified match.

3. The method of claim 2, further comprising identifying that the access request identifies a particular set of program code that allows access to one or more features of a computer associated with a multi-level-marketing (MLM) organization.

4. The method of claim 2, further comprising identifying that the access request is associated with a first set of stored data, wherein the user device is allowed to access the first set of stored data based on the identified match.

5. the method of claim 4, wherein the first set of data is stored at a second database that is different from the database.

6. The method of claim 1, further comprising identifying that the first commission schedule indicates that standard commissions and bonus commissions can be provided for receipt by one or more of the users according to the first set of rules for the sales of the products during the current time window, wherein the second set of commissions are applied to the additional sales of the products during a second time window.

7. The method of claim 6, further comprising:
identifying that the bonus commissions are associated with selling a number of products during the first time window;
identifying that the number of products have been sold during the first time window; and
distributing the bonus commissions for receipt by one or more of the users based according to the first commission schedule.

8. The method of claim 7, further comprising identifying that the bonus commissions should be provided to the one or more users based on the one or more users being part of a same product tree.

9. The method of claim 1, further comprising storing data that identifies standard commissions and bonus commissions provided for receipt by one or more of the users.

10. The method of claim 9, wherein the standard commissions are paid by a first entity and the bonus commissions are paid by a second entity.

11. A non-transitory computer-readable storage medium having embodied thereon a program for implementing a method for merchandising products, the method comprising:
identifying a first set of rules to apply based on a current time and a schedule that corresponds to a current time window;
identifying a first commission schedule to apply to sales of products according to the first set of rules during the current time window;
processing orders according to the first set of rules;
identifying, according to the schedule that the first set of rules should be changed to a second set of rules associated with a second commission schedule; and
distributing commissions for receipt by users according to the first commission schedule according to the first set of rules based on the orders being processed and fulfilled according to the first set of rules, wherein the second set of commissions are applied to additional sales of the products based on the first set of rules being changed to the second set of rules.

12. The non-transitory computer-readable storage medium of claim 11, the program further executable to:
receive data from a user device that includes a user identifier (ID) and access request information;
access a database that stores authorization data; and
identify that the user ID and the access request matches the authorization data; and wherein the user device is authorized to receive data associated with the sales of the products based identified match.

13. The non-transitory computer-readable storage medium of claim 12, the program further executable to identify that the access request identifies a particular set of program code that allows access to one or more features of a computer associated with a multi-level-marketing (MLM) organization.

14. The non-transitory computer-readable storage medium of claim 12, the program further executable to identify that the access request is associated with a first set of stored data, wherein the user device is allowed to access the first set of stored data based on the identified match.

15. the non-transitory computer-readable storage medium of claim 14, wherein the first set of data is stored at a second database that is different from the database.

16. The non-transitory computer-readable storage medium of claim 11 the program further executable to identify that the first commission schedule indicates that standard commissions and bonus commissions can be provided for receipt by one or more of the users according to the first set of rules for the sales of the products during the current time window, wherein the second set of commissions are applied to the additional sales of the products during a second time window.

17. The non-transitory computer-readable storage medium of claim 16, the program further executable to:
identify that the bonus commissions are associated with selling a number of products during the first time window;
identify that the number of products have been sold during the first time window; and
distribute the bonus commissions for receipt by one or more of the users based according to the first commission schedule.

18. The non-transitory computer-readable storage medium of claim 17, the program further executable to identify that the bonus commissions should be provided to the one or more users based on the one or more users being part of a same product tree.

19. The non-transitory computer-readable storage medium of claim 11, the program further executable to store data that identifies standard commissions and bonus commissions provided for receipt by one or more of the users.

20. The method of claim 19, wherein the standard commissions are paid by a first entity and the bonus commissions are paid by a second entity.
